(19) United States
(12) Patent Application Publication
(10) Pub. No.: US 2026/0128328 A1
(43) Pub. Date: May 7, 2026

(54) SEPARATOR FOR A FUEL CELL

(71) Applicants: HYUNDAI MOTOR COMPANY, Seoul (KR); KIA CORPORATION, Seoul (KR)

(72) Inventors: Jae Hyeon Choi, Hwaseong-si (KR); Dong Gyu Seo, Hwaseong-si (KR); Kyong Tae Lee, Hwaseong-si (KR)

(73) Assignees: HYUNDAI MOTOR COMPANY, Seoul (KR); KIA CORPORATION, Seoul (KR)

(21) Appl. No.: 19/012,236

(22) Filed: Jan. 7, 2025

(30) Foreign Application Priority Data
Nov. 5, 2024 (KR) 10-2024-0154827

(51) Int. Cl. H01M 8/0267; H01M 8/0247; H01M 8/0263

(52) U.S. Cl. CPC H01M 8/0267; H01M 8/0247; H01M 8/0263

(57) ABSTRACT

A separator for a fuel cell includes: an upper separator including first land portions and brought into close contact with an anode and a cathode of the fuel cell, and a lower separator coupled to the upper separator to form coolant passages. The lower separator has a serpentine structure including second land portions, similar to the upper separator. The first land portions of the upper separator and the second land portions of the lower separator are coupled to each other to form distribution passages, and the distribution passages link up with the coolant passages nearby.

### CROSS-REFERENCE TO RELATED APPLICATION

This application claims, under 35 U.S.C. § 119 (a), the benefit of and priority to Korean Patent Application No. 10-2024-0154827, filed on Nov. 5, 2024, the entire contents of which are incorporated herein by reference.

### TECHNICAL FIELD

The present disclosure relates to a separator for a fuel cell. More particularly, the present disclosure relates to a fuel cell separator configured to ease the movement of a coolant flowing through multiple passages and diffusion portions.

### BACKGROUND

Generally, a fuel cell is a type of power generator that converts chemical energy of fuel into electric energy through an electrochemical reaction in a fuel cell stack. Fuel cells have a wide range of applications, including serving as industrial power generators, serving as household power generators, powering vehicles, and powering small electronic devices such as portable devices. In recent years, fuel cells have increasingly been used as high efficiency clean energy sources.

A typical fuel cell stack has a membrane electrode assembly (MEA) located at the innermost portion thereof. The MEA includes a polymer electrolyte membrane (PEM) allowing transport of hydrogen ions (protons) there through, and catalyst layers (i.e., an anode and a cathode) applied on opposite surfaces of the PEM to cause hydrogen and oxygen to react.

Further, gas diffusion layers (GDLs) are laminated outside of the MEA where the anode and the cathode are located, and separators each having a flow field for supplying fuel and discharging water generated by reactions in the MEA are respectively located outside of the GDLs with gaskets interposed there between. End plates are assembled to the outermost portion of the MEA to structurally support and secure individual components described above in position.

Thus, at the anode of the fuel cell stack, an oxidation reaction in which hydrogen is oxidized takes places to generate hydrogen ions (protons) and electrons, and the generated protons and electrons flow to the cathode through the PEM and a wire, respectively. At the cathode, water is generated through an electrochemical reaction involving the protons and the electrons that have flowed from the anode, and oxygen contained in air, and this flow of electrons generates electricity.

Meanwhile, the separators are generally manufactured such that lands serving as supports and channels serving as flow paths of a fluid are alternately repeated.

In other words, a typical separator has a structure in which lands and channels (flow paths) are alternately repeated in a serpentine configuration. Owing to this structure, a channel on one side of the separator, which faces the GDL, is utilized as a space through which reactant gases such as hydrogen or air flows, while a channel on the other side is utilized as a space through which a coolant flows. Accordingly, a single unit cell may have a pair of separators, namely one separator with a hydrogen/coolant channel and the other separator with an air/coolant channel.

In such a typical separator, multiple channels are arranged symmetrically to each other, and thus, after the initial coolant flows in, it is difficult for it to move to other straight channels and diffusion portions nearby, so the distribution deviation of the coolant in the channels and diffusion portions increases, which may cause a pressure difference.

The above information disclosed in this Background section is provided only to enhance understanding of the background of the present disclosure, and therefore it may contain information that does not form the prior art that is already known to a person of ordinary skill in the art.

### SUMMARY

The present disclosure has been made in an effort to solve the above-described problems associated with the prior art, and an object of the present disclosure is to provide a separator for a fuel cell having a structure in which an upper separator having semicircular passages and a lower separator having straight passages are coupled to each other to form, on land portions, distribution passages linking up with coolant passages, allowing a coolant to be selectively distributed along the distribution passages to coolant passages nearby to reduce the distribution deviation in the coolant passages and diffusion portions, thereby reducing a differential pressure that may occur when the coolant passes through the coolant passages.

In one aspect, the present disclosure provides a separator for a fuel cell. The separator includes: an upper separator brought into close contact with an anode and a cathode of the fuel cell and including upper land portions (i.e., first land portions); and a lower separator coupled to the upper separator to form coolant passages. In particular, the lower separator has a serpentine structure including second land portions (i.e., second land portions), similar to the upper separator. In one embodiment, the first land portions of the upper separator and the second land portions of the lower separator may be coupled to each other to form distribution passages, and the distribution passages may connect to the coolant passages.

In an embodiment, the distribution passages may include a first distribution passage that includes a first passage provided in a first land portion of the first land portions and configured to connect to a first coolant passage of the coolant passages. The first distribution passage further includes a second passage having a first end and a second end that connect to the first passage. The distribution passages also include a second distribution passage provided in a second land of the second land portions and configured to connect to the first passage.

In another embodiment, the second passage of the first distribution passage may partially link up with an adjacent coolant passage among the coolant passages.

In still another embodiment, the first passage has a straight shape, and the second passage has a semicircular shape.

In yet another embodiment, the first passage has a straight shape, and the second passage has a triangular shape.

In still yet another embodiment, the first passage has a straight shape, and the second passage has a rectangular shape.

In a further embodiment, the first passage may face the second distribution passage.

In another further embodiment, the first passage may partially face the second distribution passage.

In still another further embodiment, the first passage may partially link up with the first and second ends of the second passage, and thus a gap between a middle portion of the first passage that is not linking up with the second passage and the second distribution passage may be reduced.

In yet another further embodiment, the distribution passage may be provided as at least one or more in the lengthwise direction of the upper land portion and the lower land portion.

In still yet another further embodiment, each of the distribution passages may be provided between adjacent coolant passages among the coolant passages, and the distribution passages may be on the same line with neighboring distribution passages, among the distribution passages, in the direction of gravity.

In a still further embodiment, each of the distribution passages may be provided between adjacent coolant passages among the coolant passages, and a distribution passage of the distribution passages may be diagonally apart from neighboring distribution passages, among the distribution passages, in the direction of gravity.

In a yet still further embodiment, the distribution passages may be formed at a position adjacent to a coolant diffusion portion into which a coolant is injected while being diffused.

Other aspects and embodiments of the present disclosure are further discussed below.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The above and other features of the present disclosure are now described in detail with reference to certain embodiments thereof illustrated in the accompanying drawings which are given herein below by way of illustration only, and thus are not limitative of the present disclosure, and wherein:

FIG. 1 is a view illustrating a separator for a fuel cell according to an embodiment of the present disclosure;

FIG. 2 is a view illustrating distribution passages in a separator for a fuel cell according to an embodiment of the present disclosure;

FIG. 3 is a view illustrating first distribution passages and second distribution passages in a separator for a fuel cell according to an embodiment of the present disclosure;

FIG. 4A to FIG. 4E are views illustrating the moving path of a coolant in a separator for a fuel cell according to an embodiment of the present disclosure;

FIG. 5 to FIG. 7 are views illustrating different embodiments of the first distribution passages and second distribution passages in a separator for a fuel cell according to an embodiment of the present disclosure;

FIG. 8 is a view illustrating the arrangement of distribution passages in a separator for a fuel cell according to an embodiment of the present disclosure; and

FIG. 9 and FIG. 10 are views illustrating a separator for a fuel cell of the prior art.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, should be determined in part by the particular intended application and usage environment.

In the figures, the reference numbers refer to the same or equivalent parts of the present disclosure throughout the several figures of the drawing.

### DETAILED DESCRIPTION

Hereinafter, embodiments according to the present disclosure are described in detail with reference to the accompanying drawings.

Advantages and features of the present disclosure, and a method of achieving the same, should be apparent with reference to the embodiments described below in detail in conjunction with the accompanying drawings.

However, the present disclosure may be embodied in many different forms, and should not be construed as being limited to the embodiments set forth herein. Rather, the embodiments are provided so that the present disclosure should be thorough and complete, and should fully convey the scope of the present disclosure to those having ordinary skill in the art. The present disclosure is defined only by the categories of the claims.

In describing the present disclosure, if a detailed explanation of a related known function or construction is considered to unnecessarily obscure the gist of the present disclosure, such explanation has been omitted but would be understood by those having ordinary skill in the art.

When a component, device, element, or the like of the present disclosure is described as having a purpose or performing an operation, function, or the like, the component, device, or element should be considered herein as being “configured to” meet that purpose or to perform that operation or function.

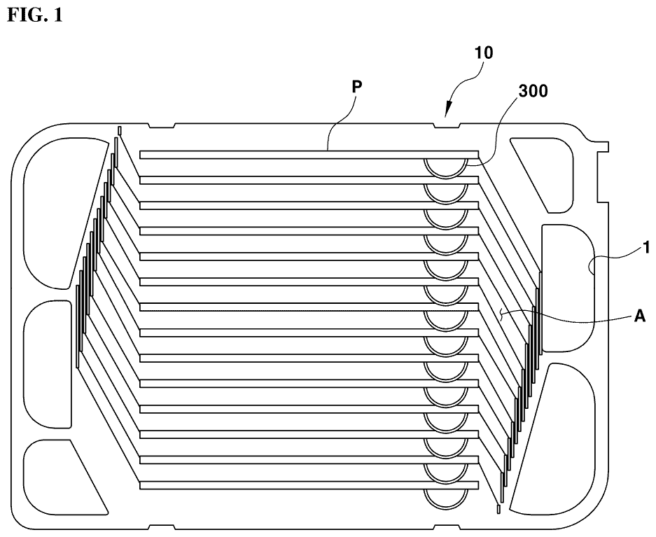

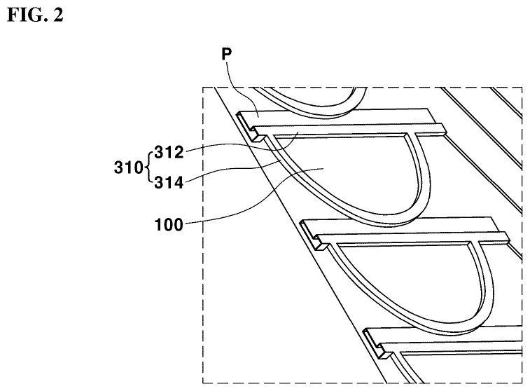

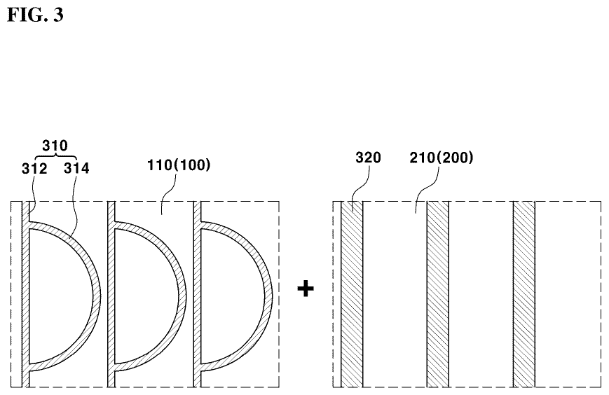

FIG. 1 is a view illustrating a separator for a fuel cell according to an embodiment of the present disclosure, FIG. 2 is a view illustrating distribution passages in a separator for a fuel cell according to an embodiment of the present disclosure, and FIG. 3 is a view illustrating first distribution passages and second distribution passages in a separator for a fuel cell according to an embodiment of the present disclosure.

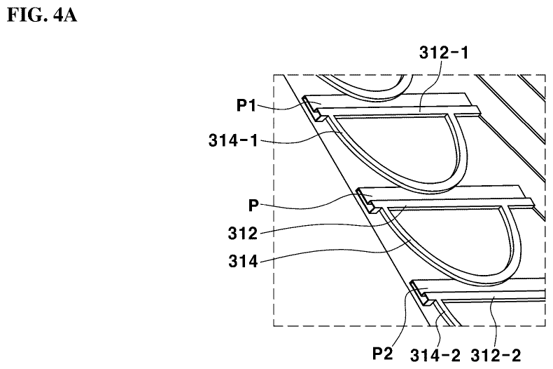

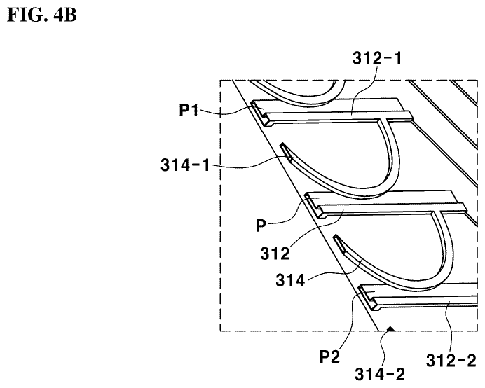

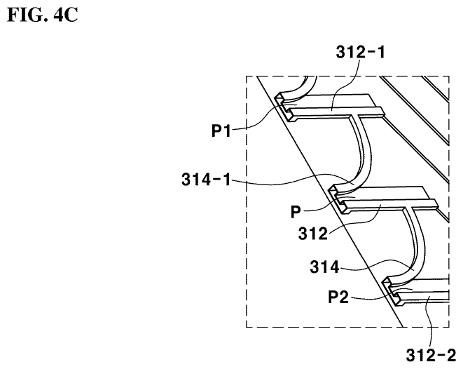

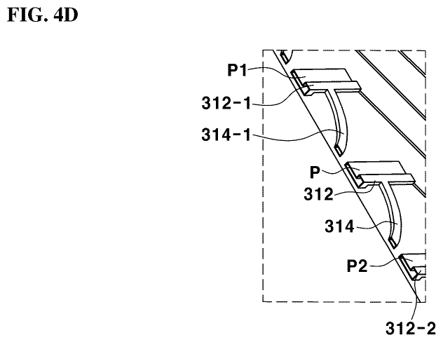

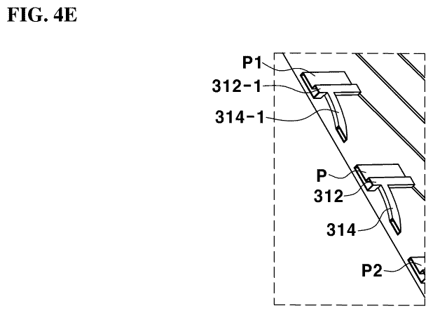

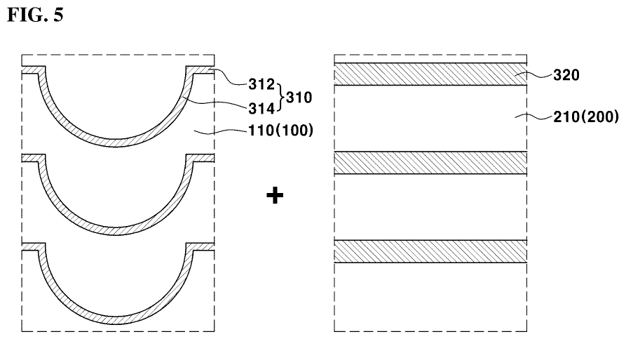

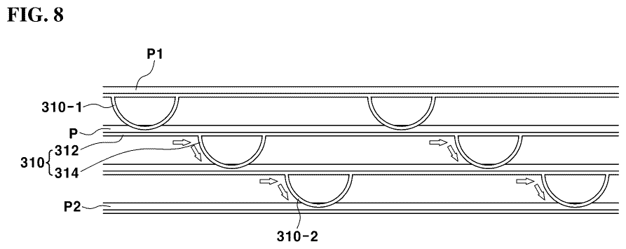

FIG. 4A to FIG. 4E are views illustrating the moving path of a coolant in a separator for a fuel cell according to an embodiment of the present disclosure, FIG. 5 to FIG. 7 are views illustrating different embodiments of the first distribution passages and second distribution passages in a separator for a fuel cell according to an embodiment of the present disclosure, and FIG. 8 is a view illustrating the arrangement of distribution passages in a separator for a fuel cell according to an embodiment of the present disclosure.

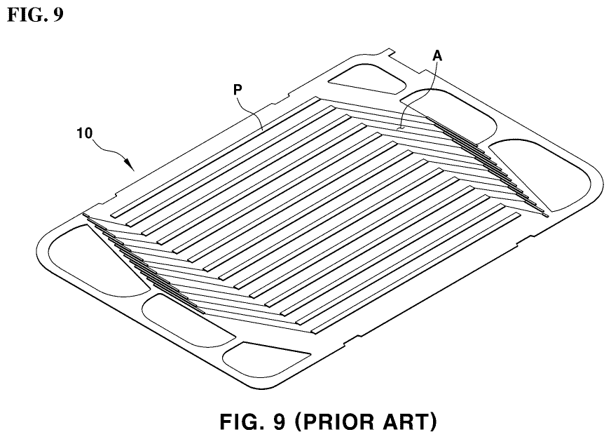

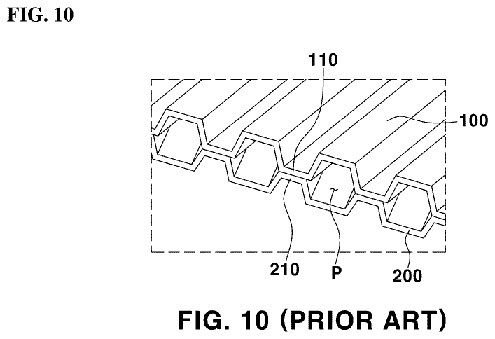

As illustrated in FIG. 9 and FIG. 10, a typical fuel cell separator 10 includes an upper separator 100 and a lower separator 200.

Here, although not illustrated in the drawing, the upper separator 100 is brought into close contact with an anode and a cathode.

More specifically, a typical fuel cell stack has a membrane electrode assembly (MEA) located at the innermost portion thereof. The MEA includes a polymer electrolyte membrane (PEM) allowing transport of hydrogen ions (protons) there through, and catalyst layers (i.e., an anode and a cathode) applied on opposite surfaces of the PEM to cause hydrogen and oxygen to react.

Further, gas diffusion layers (GDLs) are laminated outside of the MEA where the anode and the cathode are located, and separators each having a flow field for supplying fuel and discharging water generated by reactions in the MEA are respectively located outside of the GDLs with gaskets interposed there between. End plates are assembled to the outermost portion of the MEA to structurally support and secure individual components described above in position.

Here, the upper separator 100 is designed with a repeatedly curved shape (see FIG. 9 and FIG. 10). The upper separator 100 has passages formed to face the gas diffusion layer on one side thereof. The passages may be utilized as a space through which reaction gasses such as hydrogen or air flows, while the upper separator 100 has other passages formed on another side thereof, wherein the other passages may be utilized as a space through which a coolant flows.

The lower separator 200 is also designed with a repeatedly curved shape, including a plurality of passages, and lower land portions 210 similar to upper land portions 110 of the upper separator 100. Therefore, the upper land portion 110 and the lower land portion 210 are coupled to each other to form the fuel cell separator 10 and create coolant passages P between them (see FIG. 9 and FIG. 10).

As illustrated in FIGS. 1-3, upper land portions 110 formed on an upper separator 100 and lower land portions 210 formed on a lower separator 200 are coupled to each other to form distribution passages 300 linking up with nearby coolant passages P.

In the prior art, when a coolant is injected while being diffused from a coolant inlet manifold 1, the injected coolant cannot move to nearby coolant passages P having a straight shape, and it is also difficult for the injected coolant to be distributed to diffusion portions A at the opposite side, inevitably causing a distribution deviation of the coolant in the coolant passages P and diffusion portions A, thereby increasing the pressure difference in the plurality of coolant passages P (see FIG. 9 and FIG. 10).

So as to solve such problems, in this embodiment, upper land portions 110 formed on an upper separator 100 and lower land portions 210 formed on a lower separator 200 are coupled to each other to form distribution passages 300 linking up with nearby coolant passages P. In one form, the distribution passages 300 are connected or interconnected with the adjacent coolant passages P to provide a continuous flow of coolant.

The distribution passage 300 may be formed at a position adjacent to a diffusion portion A into which a coolant is injected while being diffused from a coolant inlet manifold 1 to a coolant passage P, and may include, as illustrated in FIG. 3, a first distribution passage 310 and a second distribution passage 320.

The distribution passage 300 including the first distribution passage 310 and the second distribution passage 320 may be provided as one or more in the lengthwise direction of an upper land portion 110 and a lower land portion 210 (see FIG. 8).

Moreover, the distribution passages 300 may be provided between each of nearby coolant passages P, P1, and P2, and may be provided on the same line as the distribution passages neighboring in the direction of gravity, as illustrated in FIG. 1

The arrangement of distribution passages 300 being provided on the same line as the nearby distribution passages is only applied to any one embodiment and is not limited thereto. As illustrated in FIG. 8, the distribution passages 300 may be provided between each of nearby coolant passages P, P1, and P2, but may be diagonally apart from distribution passages 310-1 and 310-2 neighboring in the direction of gravity, allowing the coolant to be easily distributed and flowed in the direction of gravity.

In one embodiment, the first distribution passage 310 is provided on the upper land portion 110 and includes: a first passage 312 linking up with the coolant passage P, and a second passage 314 having one end and another end linking up with the first passage 312.

In other words, the first distribution passage 310 has a straight shape same as the coolant passage P having a straight shape and includes the first passage 312 linking up (i.e., fluidly communicating) with the coolant passage P at one end and another end thereof. The first distribution passage 310 further includes the second passage 314 coming from one end of the first passage 312 to link up with another end of the first passage 312. In other words, the second passage 314 branches from one side of the first passage 312 and reconnects to the other side in a fluid-communicating structure.

In one form, the first distribution passage 310 may include the first passage 312 having a straight shape and the second passage 314 having a semicircular shape. Both ends of the second passage 314 may link up with or connect to the first passage 312.

Because the second passage 314 has a semicircular shape, a coolant may flow to a nearby coolant passage P1 at one side and may flow to a nearby coolant passage P2 at another side, as illustrated in FIGS. 4A-4E.

Referring to FIGS. 4A-4E, the moving path of a coolant to the nearby coolant passage P1 at one side and to the nearby coolant passage P2 at another side with respect to the coolant passage P is described in detail as follows.

When a coolant is introduced into the first passage 312 linking up with the coolant passage P as illustrated in FIG. 4A, the coolant flows through the straight first passage 312 as illustrated in FIG. 4B, and at the same time, flows to the nearby coolant passage P2 through the semicircular second passage 314.

Here, the coolant in the coolant passage P1 moving along a semicircular second passage 314-1 of the coolant passage P1 flows toward the coolant passage P, and the coolant introduced into the coolant passage P2 flows along a first passage 312-2.

As illustrated in FIG. 4C and FIG. 4D, the coolant moving in a straight direction along the first passage 312 of the coolant passage P moves toward the coolant passage P1 through the second passage 314-1 because the first passage 312 links up with the semicircular second passage 314-1 of the coolant passage P1. The coolant moving along the semicircular second passage 314 of the coolant passage P moves toward the coolant passage P2 because the semicircular second passage 314 links up with the nearby coolant passage P2.

As illustrated in FIG. 4E, the coolant in the coolant passage P moving to the coolant passage P1 along the second passage 314-1 is moved toward the coolant passage P1 along the first passage 312-1. At the same time, the coolant in the coolant passage P2 moving to the coolant passage P along the second passage 314 is moved toward the coolant passage P along the first passage 312.

In this embodiment, through the first distribution passage 310 including the first passage 312 and the second passage 314, more specifically, through the first distribution passage 310 having the second passage 314 overlapping the nearby coolant passage P, the coolant in the coolant passage P may be distributed to the nearby coolant passages P1 and P2, thereby reducing the distribution deviation of the coolant to the plurality of coolant passages P. Therefore, the differential pressure that may occur when the coolant passes through the plurality of coolant passages P may be reduced.

However, the implementation of the first passage 312 having a straight shape and the second passage 314 having a semicircular shape is only applied to any one embodiment and is not limited thereto. The second passage 314 may have various shapes.

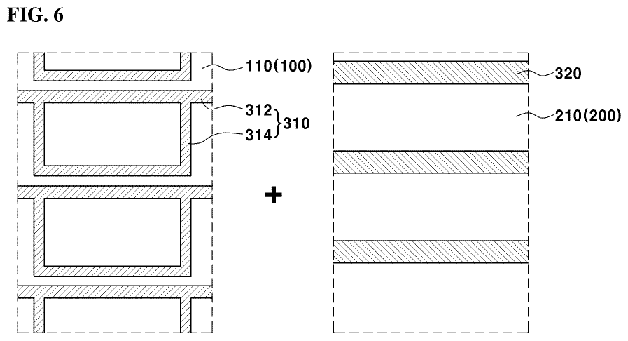

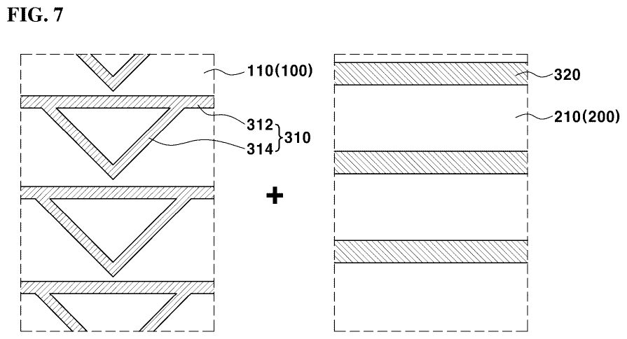

In one example, as illustrated in FIG. 6, the second passage 314 may have a rectangular shape and link up with the nearby coolant passages P1 and P2. Or, as illustrated in FIG. 7, the second passage 314 may have a triangular shape and link up with the nearby coolant passages P1 and P2.

In a different embodiment, the first passage 312 may be, as described above, provided on the upper land portion 110 to face the second distribution passage 320, which, however, is only applied to any one embodiment and is not limited thereto.

In other words, the first passage 312 may extend in a straight shape, similar to the second distribution passage 320 as described above (see FIG. 3), or the first passage 312, except for the middle portion thereof, may link up with one end and another end of the second passage 314 as illustrated in FIG. 5.

Put differently, because the first passage 312 partially connects to the one end and the other end of the second passage 314, when the upper separator 100 and the lower separator 200 are coupled to each other, the vertical gap between the middle portion of the first passage 312 (which does not connect to the second passage 314) and the second distribution passage 320 on the lower land portion 210 may be reduced.

In this structure, the gap between the middle portion of the first passage 312 and the second distribution passage 320 is smaller than the gap between the portion of the first passage 312 linking up with the one end and the other end of the second passage 314 and the second distribution passage 320, and thus, the flow speed of the coolant passing there through may be increased, allowing the coolant to be more effectively distributed.

As illustrated in FIG. 3, the second distribution passage 320 is provided on the lower land portion 210 and links up with the coolant passage P and the first passage 312 included in the first distribution passage 310 on the upper land portion 110.

The second distribution passage 320 may have a straight shape, similar to the first passage 312, and may have a width greater than a width of the first passage 312.

Although, in this embodiment, it is described that the fuel cell separator 10 has a structure in which the upper land portion 110 has the first distribution passage 310, including the first passage 312 and the second passage 314, formed thereon, and the lower land portion 210 has the second distribution passage 320 formed thereon. Such a structure is applied to one embodiment only and is not limited thereto. For example, the fuel cell separator 10 may also have a structure in which the upper land portion 110 has the second distribution passage 320 formed thereon, as described in the above embodiment, and the lower land portion 210 has the first distribution passage 310, including the first passage 312 and the second passage 314, formed thereon, as described in the above embodiment.

As is apparent from the above description, the present disclosure provides the following effects.

In the present disclosure, an upper separator having semicircular passages and a lower separator having straight passages are coupled to each other to form, on land portions, distribution passages linking up with coolant passages, allowing a coolant to be selectively distributed along the distribution passages to the coolant passages nearby, thereby reducing the distribution deviation in the coolant passages and diffusion portions.

Accordingly, a differential pressure that may occur when the coolant passes through the coolant passages may be reduced.

In the above, embodiment(s) of the present disclosure have been described with reference to the accompanying drawings. However, those having ordinary skill in the art to which the present disclosure pertains should understand that various modifications may be made therefrom, and that all or part of the above-described embodiment(s) may be selectively combined. Therefore, the true technical protection scope of the present disclosure should be determined by the technical ideas of the appended claims.

What is claimed is:

1. A separator for a fuel cell, the separator comprising:
an upper separator brought into close contact with an anode and a cathode of the fuel cell and including first land portions; and
a lower separator coupled to the upper separator to form coolant passages, wherein the lower separator has a serpentine structure including second land portions,
wherein the first land portions of the upper separator and the second land portions of the lower separator are coupled to each other to form distribution passages, and the distribution passages are configured to connect to the coolant passages.

2. The separator of claim 1, wherein the distribution passages comprise:
a first distribution passage comprising:
a first passage provided in a first land portion of the first land portions and configured to connect to a first coolant passage of the coolant passages, and
a second passage having a first end and a second end that are configured to connect to the first passage; and
a second distribution passage provided in a second land portion of the second land portions and configured to connect to the first passage.

3. The separator of claim 2, wherein, in the first distribution passage, the second passage partially links up with an adjacent coolant passage among the coolant passages.

4. The separator of claim 2, wherein the first passage has a straight shape, and the second passage has a semicircular shape.

5. The separator of claim 2, wherein the first passage has a straight shape, and
the second passage has a triangular shape.

6. The separator of claim 2, wherein the first passage has a straight shape, and
the second passage has a rectangular shape.

7. The separator of claim 2, wherein the first passage faces the second distribution passage.

8. The separator of claim 2, wherein the first passage partially faces the second distribution passage.

9. The separator of claim 8, wherein the first passage partially links up with the first and second ends of the second passage such that a gap between a middle portion of the first passage that is not linking up with the second passage and the second distribution passage is reduced.

10. The separator of claim 1, wherein the distribution passages include at least one or more distribution passages along a lengthwise direction of the first land portions and the second land portions.

11. The separator of claim 10, wherein each of the distribution passages is provided between adjacent coolant passages among the coolant passages, and the distribution passages are on a same line with neighboring distribution passages, among the distribution passages, in a gravity direction.

12. The separator of claim 10, wherein the distribution passages are each provided between adjacent coolant passages among the coolant passages, and a distribution passage of the distribution passages is diagonally apart from neighboring distribution passages, among the distribution passages, in a gravity direction.

13. The separator of claim 1, wherein the distribution passages are formed at a position adjacent to a coolant diffusion portion into which a coolant is injected while being diffused.
